(19) United States
(12) Patent Application Publication
(10) Pub. No.: US 2024/0247377 A1
(43) Pub. Date: Jul. 25, 2024

(54) FOOD CONTACT MEMBER AND SURFACE TREATMENT METHOD THEREOF

(71) Applicant: FUJI KIHAN CO., LTD., Nagoya-shi Aichi (JP)

(72) Inventor: Yoshio MIYASAKA, Nagoya-shi Aichi (JP)

(21) Appl. No.: 18/591,934

(22) Filed: Feb. 29, 2024

Related U.S. Application Data
(62) Division of application No. 17/258,294, filed on Jan. 6, 2021.

(30) Foreign Application Priority Data
Jul. 20, 2018 (JP) 2018-137113

(51) Int. Cl. C23C 24/04; A47J 36/02; C21D 7/06; C23C 8/64; C23F 17/00

(52) U.S. Cl. CPC C23C 24/04; A47J 36/02; A47J 36/025; C21D 7/06; C23C 8/64; C23F 17/00; B23P 2700/05

(57) ABSTRACT

A food product contact member that makes contact with a food product. The food product contact member is configured from a metal or a substance containing a metal. The food product contact member includes a contact surface making contact with the food product and having a micronized structure. Plural smooth circular arc shaped depressions without pointed protrusions are formed over an entirety of the contact surface. Titanium oxide is diffused and penetrated at a proximity to a surface of the contact surface contacting the food product.

### FIELD OF THE INVENTION

The present invention relates to a food product contact member and to a method for surface treatment performed to at least a food product contacting portion thereof. Examples of members collectively referred to as the “food product contact member” of the present invention include: configuration members that contact a food product from out of configuration members of food product manufacturing devices and food product conveying devices, food product metering devices, food product testing devices, and various other devices that handle food products; and members that themselves contact a food product, such as packaging containers employed to package a food product, cooking utensils employed in food product preparation, and the like.

Note that references in the present invention to “food product” includes all products that are consumed by either eating or drinking, including foods and drinks, medical products and quasi-medicines such as medicines taken internally, supplements, and the like, and these are all referred to here as “food products”.

Moreover, the “food product” in the present invention encompasses food products in their final state for consumption by eating or drinking, as well as raw materials and intermediate products thereof.

### BACKGROUND OF THE INVENTION

For the above food product contact members that include a food product contacting surface, food product contacting portions of the food product contact member are sometimes formed from a fluorine-based resin material, or a fluoroplastic material is coated on the surface of the food product contacting portions, in order to prevent a food product from sticking to the surface and in order to achieve properties such as antifouling and anticorrosion.

As an example, there is proposed as in Patent Document 1 listed below for a food product baking machine that imparts a golden brown color to a dumpling or other food product by baking the food product. A heatproof-sheet belt formed from a fluoroplastic material is detachably mounted around the entire peripheral surface of a food product conveying belt on which a food product is placed.

Moreover, Patent Document 2 listed below discloses a fluoroplastic film covered steel sheet employed in a baking mold for bread or cakes, or in a food product cooking utensil, heated-cooking utensil, or the like such as a frying pan, or a rice cooker pan.

### PRIOR ART DOCUMENTS

### Patent Documents

Patent Document 1: Japanese Patent No. 5319008
Patent Document 2: Japanese Patent Application Laid-Open No. H09-136382

### Problems to be Solved by the Invention

A fluoroplastic has excellent water repellency and oil repellency, and also has excellent properties from the perspective of chemical resistance, weather resistance, electrical insulation, wear resistance, and the like. Thus forming a food product contact member from a fluoroplastic material or coating a surface of a food product contact member with a fluoroplastic, as described above, not only makes dirt and the like less liable to stick, but also enables improvements to be made to the weather resistance, and the corrosion resistance and wear resistance of a food product contact member.

However, due to a fluoroplastic having the characteristics described above, fluoroplastic materials are difficult to work, and this results in limitations being place on the working method and attachment structure when attempting to form a food product contact member or a portion thereof with a fluoroplastic, due to poor adhesiveness to other members and the like.

Moreover, in a configuration in which a fluoroplastic is coated, the above advantageous effects are lost when the coating film detaches from the surface of the food product contact member with the passage of time. This means that it is required to periodically re-coat the fluoroplastic or to replace a member whose coating has detached. This not only means that maintenance becomes troublesome, but also a concern that detached flakes might be incorporated into a food product as a foreign object.

Moreover, it has been reported that a highly poisonous gas is generated when a fluoroplastic is heated to a certain temperature or greater (a temperature of from 315° C. to 375° C. for polytetrafluoroethylene (PTFE), which is a typical example of a fluoroplastic). This means that it is not possible to burn off old detached fluoroplastic prior to re-coating, and so not only is the expense incurred for processing high due to needing to dispose of the old fluoroplastic by a safe method, but the food product contact member is also not able to be used at a temperature of the above heating temperature referred to above or greater.

Furthermore, in powder packing machines employed for medical products or the like, it has been reported that powder flow deteriorating when a fluoroplastic is coated on a powder contacting surface due to the generation of static electricity.

There has accordingly recently been a tendency in the food product handling business to withhold employing fluoroplastics on the above food product contact members that contact food products which people will put in their mouths.

Note that although there are investigations being performed into surface treatment methods to employ instead of fluoroplastic coating for such food product contact members, such as diamond-like carbon (DLC) coating, there is a large increase in cost when DLC coating is performed compared to cases in which fluoroplastic coating is performed. There is accordingly a desire to replace fluoroplastics with a surface treatment method and food product contact member capable of imparting non-stick and antifouling properties with respect to a food product, corrosion resistance, wear resistance, antibacterial properties and the like to a food product contact member by using a comparatively simple treatment having a lower cost than DLC coating.

Moreover, even with DLC coating, because it is a coating, there is still a concern that flakes arising from detachment of the coating film might be incorporated as foreign objects into food products, similarly to in cases in which fluoroplastic coating is employed.

In order to prevent incorporation of foreign objects into food products due to such detachment of coating films, a configuration should be adopted in which there is no coating film provided on the surface of the food product contact member. However, due to rust being generated on the surface of a food product contact member by contact with moisture, salt, etc. contained in the food product, not only does food product and dirt readily stick to the portions where rust has been generated, but there is also a concern that developing rust might detach and be incorporated into the food product as a foreign object.

Therefore, it has been required to impart corrosion resistance and antirust properties by some sort of method in a configuration in which a coating film is not formed on the surface of the food product contact member.

The present invention has accordingly been arrived at to address the desires listed above, and an object of the present invention is to provide a food product contact member and a surface treatment method thereof which, while being a surface treatment capable of low cost execution by comparatively simple processing, at the same time imparts antifouling properties and corrosion resistance, rust prevention properties, wear resistance, antibacterial properties, and the like to the surface of the food product contact member while not suffering from the harmful effects such as the incorporation of foreign objects into a food product or the generation of a poisonous gas when heated or the like.

### SUMMARY OF INVENTION

### Means for Solving the Problem

In order to achieve the above objective, a food product contact member that makes contact with a food product is characterized in that:
the food product contact member is configured from a metal or a substance containing a metal;
the food product contact member includes a contact surface making contact with the food product and having a micronized structure;
plural smooth circular arc shaped depressions without pointed protrusions are formed over an entirety of the contact surface; and
titanium oxide is diffused and penetrated at a proximity to a surface of the contact surface contacting the food product.

The thickness of a surface layer containing the titanium oxide may be approximately 0.5 μm;
the titanium oxide may be activated and adsorbed to the micronized surface structure formed on the surface of the food product contact member; and
the titanium oxide is diffused and penetrated to a depth of approximately 5 μm inward from a surface of a member of the food product contact member.

The titanium oxide diffused and penetrated into the surface layer may have a tilting structure in which there is a lot of bonding with oxygen at a proximity to the surface of the food product contact member and the amount of bonding with oxygen gradually decreases on progression further inward from the surface.

In order to achieve the above objective, a method for surface treatment of a food product contact member of the present invention comprises:
taking a food product contact member that makes contact with a food product and is configured from a metal or a substance including a metal;
performing instantaneous heat treatment on the food product contact member by ejecting and colliding substantially spherical shot against a contact surface of the food product contact member which makes contact with the food product so as to micronize a structure of the contact surface making contact with the food product and so as to form multiple smooth circular arc shaped depressions without pointed protrusions over the contact surface entirely, the substantially spherical shot having a hardness equal to or more than a surface hardness of the contact surface, a size of from 220 grit to 800 grit (JIS R6001-1973), and being ejected at an ejection pressure of not less than 0.2 MPa so as to cause a local and instantaneous rise in temperature at portions collided by the substantially spherical shot; and
ejecting a powder made from titanium or a titanium alloy of a size from 100 grit to 800 grit (JIS R6001-1973) against the contact surface of the food product contact member subjected to instantaneous heat treatment at an ejection pressure of not less than 0.2 MPa so as to cause titanium oxide to diffuse and penetrate at a proximity to a surface of the contact surface which contacts with the food product.

A preliminary treatment step may be performed prior to the instantaneous heat treatment by ejecting a carbide powder having a size of from 220 grit to 800 grit (JIS R6001-1973) against at least a portion that contacts the food product on the food product contact member at an ejection pressure of not less than 0.2 MPa so as to cause carbon element in the carbide powder to diffuse into a surface of the food product contact member.

The carbide powder ejected in the preliminary treatment step is preferably a powder of silicon carbide, more preferably SiCa.

### Effect of the Invention

Due to adopting the configuration of the present invention as described above, the food product contact member of the present invention and the surface treatment method thereof enable the following significant advantageous effects to be obtained.

For a food product contact member subjected to the surface treatment by the method of the present invention, a comparatively simple method of ejecting two types of particle enables a surface to be formed on the food product contact member that is a surface to which a food product or dirt is not liable to stick, that has excellent wear resistance and corrosion resistance, and that moreover exhibits an antibacterial action.

Moreover, the surface treatment method of the present invention enables the above advantageous effects to be imparted to the food product contact member by a comparatively simple operation of particle ejection. This not only enables surface treatment to be performed with a shorter lead time to delivery, but in contrast to fluoroplastic coating, does not achieve antifouling and the like by forming a coating film. Instead the advantageous effects described above are achieved, as described above, by micronization of the surface structure and forming of circular arc shape depressions in the instantaneous heat treatment, and by the diffusion and penetration of titanium oxide by the titanium powder ejection. The advantageous effects of the surface treatment are accordingly not lost by detachment of a coating film. Moreover, the provision is enabled of a food product contact member and surface treatment method thereof, for which there are no concerns regarding flakes of detached coating film being incorporated as foreign objects into a food product.

Furthermore, in the food product contact member subjected to the surface treatment by the method of the present invention, not only there is no concern regarding generation of a poisonous gas by heating, as is the case with a fluoroplastic coating, but the titanium oxide that has diffused and penetrated into the surface of the food product contact member exhibits a photocatalyst-like or semiconductor catalyst-like function. In particular, by catalytic activation on heating, not only is corrosion resistance improved and a rust prevention effect obtained by the reduction action of the catalyst, but functions can be exhibited that are suited to machines and utensils which contact a food product, such as odor prevention and deodorization, decomposition of poisonous gases, antibacterial and antifungal properties, and the like.

Note that in cases in which a preliminary treatment step is performed of ejecting a specific carbide powder, such as a silicon carbide (SiC) powder and preferably a SiCa powder, against a surface of the food product contact member prior to the instantaneous heat treatment, the carbon element in the carbide powder diffuses and penetrates into the surface of the food product contact member. This enables the hardness at a proximity to the surface to be further raised, and moreover enables an improvement in the wear resistance to be obtained, enabling the advantageous effects obtained by the surface treatment described above to be maintained for a longer period of time.

### BRIEF DESCRIPTION OF THE DRAWINGS

FIG. 1 is a photograph imaging a surface state of a test piece (untreated) after a CASS test.

FIG. 2 is a photograph imaging a surface state of a test piece (Example) after a CASS test.

### EMBODIMENTS TO CARRY OUT THE INVENTION

Explanation follows regarding a surface treatment method for a food product contact member of the present invention.

### Treatment Target: Food Product Contact Member

In the surface treatment method of the present invention, the food product contact member of the present invention is any member that has a food product contacting surface. Such members include food product contacting configuration members from out of configuration members of food product manufacturing devices, food product conveying devices, food product metering devices, food product testing devices, and various other devices that handle food products. For example, the food product contacting surface includes the internal faces of hoppers and chutes, the outer peripheral face of rollers for rolling out confectionary and noodle doughs, trays and wire mesh surfaces for placing food products on, and molding surfaces of molds for molding food products provided in such devices, and packaging containers employed to package food products (for example cans) and cooking utensils such as frying pans, pots, and the like.

The substance of the food product contact member subjected to treatment is not particularly limited as long as it contains a metal. For example, food product contact members of various steels such as stainless steels (SUS steels), carbon tool steels (SK steels), or tool-steel alloys (SKS, SKD, SKT steels), may each be subjected to the treatment of the present invention. Moreover, food product contact members of various substances may be subjected to treatment, such as food product contact members made from other steel materials such as high speed tool steels (SKH steels), from sintered metals such as cemented carbides, Cu—Be alloys, and from other non-ferrous metal alloys.

Moreover, the food product contact member is not necessary formed entirely of a metal material, and may include other components, such as ceramic parts for example.

### Surface Treatment

The surface treatment of the present invention as described below is performed on at least a surface of a food product contacting portion of one of the food product contact members described above.

### (1) Preliminary Treatment Step

The present step (preliminary treatment step) is a step performed as required, and as such is a step that is not necessarily always performed, depending on the application etc. for the food product contact member, and is not an essential step of the present invention.

In the present step, a carbide powder is dry-ejected against a surface of a food product contact member serving as the treatment target so as to prepare the surface by removing an electrical discharge hardened layer and softened layer arising on the surface due to electrical discharge processing or cutting processing during manufacture of the food product contact member, or by removing directional processing marks (cutting marks, polishing marks, tool marks and the like) generated during cutting, grinding, and polishing processes. In addition thereto, carbon element present within the carbide powder is caused to diffuse and penetrate into the surface of the food product contact member, so as to perform carburizing at normal temperatures.

Examples of carbide powders that may be employed include the powders of carbides or carbon containing substances such as B₄C, SiC (SiC(a)), TiC, VC, graphite, diamond, and the like (in the present invention, simply referred to as “carbide powder”). SiC is preferably employed therefor, and SiC(a) is more preferably employed therefor.

When employed either for the objective of removing an electrical discharge hardened layer or softened layer, or removing directional processing marks, so that the carbide powder employed exhibits a high cutting force an angular powder is preferably employed therefor, the angular powder being obtained for example by crushing a sintered carbide based ceramic and then sieving. The shape of the carbide powder is not particularly limited in cases lacking such a cutting objective, and a carbide powder with a spherical shape or one with various other shapes may be employed.

In order to obtain an ejection velocity required to achieve diffusion and penetration of carbon element, the size of the powder employed has a size of from 220 grit (JIS R6001-1973) (from 44 μm to 105 μm) to 800 grit (JIS R6001-1973) (average of average diameter from 18 μm to 22 μm), and preferably the powder employed has a size of 240 grit (JIS R6001-1973) (average of average diameter from 73.5 μm to 87.5 μm) or smaller particle diameter (larger grit number), so-called “fine particles”.

Various known blasting apparatuses capable of dry-ejecting a powder may be employed as the method for ejecting such a carbide powder onto the surface of the food product contact member. An air type blasting apparatus is preferably employed therefor due to the comparative case with which the ejection velocity and the ejection pressure can be adjusted.

A direct pressure type blasting apparatus, suction gravity type blasting apparatus, or various other types of blasting apparatus may be employed as such an air type blasting apparatus. Any of these types of blasting apparatus may be employed, and the type thereof is not particularly limited as long as it has a performance capable of dry-ejecting at an ejection pressure of not less than 0.2 MPa.

When a carbide powder as described above is dry-ejected at high speed using such a blasting apparatus against a surface at food product contacting portions of a food product contact member, electrical discharge hardened layers and softened layers, directional processing marks, and the like arising during manufacture of the food product contact member from electrical discharge processing and cutting processing are removed so as to prepare a non-directional surface of the food product contact member.

Moreover, the collision of the carbide powder against the surface of the food product contact member causes a localized rise in temperature on the surface of the food product contact member at portions collided by the carbide powder. The carbide powder is also heated and undergoes thermal decomposition. As the carbon element present within the carbide of the carbide powder diffuses and penetrates into the surface of the food product contact member, the carbon content of these portions increases, enabling the hardness of the surface of the food product contact member after performing the preliminary treatment step to be greatly increased.

In the preliminary treatment of the present invention, the carbide powder undergoes decomposition through thermal decomposition due to the temperature of the carbide powder rising when the carbide powder is caused to collide the food product contact member by the blast processing serving as the preliminary treatment described above. Carburizing treatment is accordingly performed by the thus generated carbon element present within the carbide powder diffusing and penetrating into the surface of the food product contact member.

According to the preliminary treatment by this method, the diffusion and penetration of carbon element into the food product contact member is most significant at the greatest proximity to the surface, with this also resulting in a great increase in the carbon content. The carbon content increases due to diffusion toward the inside of the food product contact member. This results in the generation of a tilting structure in which the carbon content at depth gradually decreases with distance (depth) from the surface of the food product contact member, with the carbon content decreased to that of an untreated state by a certain depth.

The carbide powder and the food product contact member undergo a partial rise in temperature when the carbide powder collides the surface of the food product contact member. However, the rise in temperature is only localized and instantaneously. Distortion, phase transformation, or the like in the food product contact member, such as that caused by heat treatment in an ordinary carburizing treatment performed by heating the entire food product contact member in a carburizing furnace, is accordingly not liable to occur. Moreover, higher adhesion strength is achieved due to the generation of fine carbides, and an irregular carburized layer is not generated.

### (2) Instantaneous Heat Treatment Step

The present step (instantaneous heat treatment step) is performed on at least a surface of a portion that will contact a food product of the food product contact member serving as the treatment target (a surface after the preliminary treatment step in cases in which the preliminary treatment step described above has been performed). The present process is performed to dry-eject spherical powders so as to form innumerable fine depressions having circular arc shapes on the surface of the food product contact member, and so as to further increase the surface hardness by micronization of structure at a proximity to the surface of the food product contact member.

There are no particular limitations to the substance of the spherical powder employed therefor, as long as the spherical powder has a hardness that is not less than the hardness of the food product contact member to be treated. For example, as well as spherical powders made from various metals, a spherical powder made from a ceramic may be employed, and a spherical powder made from a similar substance to the carbide powders described above (carbides or carbon containing substances) may also be employed therefor.

The spherical powder employed is spherical to an extent that enables innumerable fine indentations having a circular arc shape as described above to be formed on the surface of the food product contact member.

Note that “spherical shaped” in the present invention need not refer strictly to a “sphere”, and also encompasses non-angular shapes close to that of a sphere.

Such spherical powders can be obtained by atomizing methods when, for example, the spherical powder is a metallic substance, and can be obtained by crushing and then melting when the substance of the powder is a ceramic.

In order to achieve the ejection velocity needed to plastically deform the surface of the food product contact member by collision to form semi-circular shaped indentations (dimples), the particle diameter of the powder employed therefor has a size of from 220 grit (JIS R6001-1973) (from 44 μm to 105 μm) to 800 grit (JIS R6001-1973) (average of average diameter from 18 μm to 22 μm), and preferably the powder employed has a size of 240 grit (JIS R6001-1973) (average of average diameter from 73.5 μm to 87.5 μm) or smaller particle diameter (larger grit number), so-called “fine particles”.

Moreover, various known blasting apparatuses with dry-ejection capabilities, similar to those explained with respect to the ejection method for carbide powder when explaining the preliminary treatment step, may be employed as the method for ejecting the spherical powder onto the surface of the food product contact member in such a manner. The type and the like of the blasting apparatus is not particularly limited, as long as it has the performance capable of ejecting at an ejection pressure of not less than 0.2 MPa.

The spherical powder such as described above is ejected against the food product contacting surface of the food product contact member, and the collision of the spherical powder results in plastic deformation occurring on the surface of the food product contact member at the portions collided by the spherical powder.

As a result, even in cases in which the preliminary treatment step has been performed by employing the angular shaped carbide powder, and even in cases in which indentations and protrusions having acute apexes were formed on the surface of the food product contact member in cutting achieved by the collision of such a carbide powder, the surface roughness is improved by collapsing the acute apexes, and by randomly forming innumerable smooth depressions (dimples) with circular arc shapes on the entire surface of the food product contact member.

Moreover, due to the heat generated when collided by the spherical powder, the collided portions experience instantaneous local heating and cooling. Accompanying this instantaneous heat treatment, fine crystallization occurs at the surface of the food product contact member and the surface of the food product contact member undergoes work hardening due to plastic deformation when the circular arc shape depressions are formed. The surface hardness of the food product contact member is thereby further increased from that of the state after the preliminary treatment step. Moreover, due to a compressive residual stress being imparted by the plastic deformation of the surface, this is also thought at the same time to contribute to the advantageous effect of an increase in the fatigue strength and the like of the food product contact member, in an effect obtained by so-called “shot peening”.

### (3) Titanium Powder Ejection

A powder of titanium or titanium alloy (hereafter also referred to collectively as a “titanium powder”) is also ejected against at least the food product contacting surfaces of the food product contact member after being subjected to the instantaneous heat treatment as described above. Titanium oxide is thereby caused to diffuse and penetrate into the surface of the food product contact member.

Such a titanium powder is not particularly limited in shape as long as the titanium powder has a size of from 100 grit (JIS R6001-1973) (from 74 μm to 210 μm) to 800 grit (JIS R6001-1973) (average of average diameter from 18 μm to 22 μm), and the titanium powder employed may be spherical, angular shaped, or various other shapes.

Moreover, a powder of a precious metal (such as Au, Ag, Pt, Pd, or Ru) having an effect of promoting the catalytic function of the titanium oxide may be mixed in with the titanium powder at a range of from approximately 0.1% to about 10% mass ratio, and ejected therewith.

Note that in the following description, the term titanium powder is employed as a collective term that also encompasses titanium powders incorporating a precious metal, unless explanation particularly differentiates between a precious metal powder and a titanium powder.

In cases in which a titanium powder mixed with a precious metal powder is ejected, the particle diameters of both powders are not necessarily always the same diameter, and a titanium powder and a precious metal powder having different particle diameters may be employed.

In particular, the specific weight of precious metal powders is greater than that of titanium powders, and the particle diameter of the precious metal powder may be made smaller than that of the titanium powder so as to bring the masses of each particle of the two powders closer together, in an adjustment such that the ejection velocities of both powders are substantially the same as each other.

Moreover, various known blasting apparatuses with dry-ejection capabilities, similar to those explained with respect to the ejection method for carbide powder or spherical shot when explaining the preliminary treatment step or the instantaneous heat treatment step, may be employed as the method for ejecting the titanium powder described above onto the surface of the food product contact member. The type and the like of the blasting apparatus is not particularly limited, as long as it has the performance capable of ejecting at an ejection pressure of not less than 0.2 MPa.

Ejecting the titanium powder as described above to cause the titanium powder to collide against the surface of the food product contact member including the surface finely crystalized by the instantaneous heat treatment step results in the velocity of the titanium powder changing between before and after collision, and in energy of an amount equivalent to the deceleration in velocity becoming thermal energy to locally heat the collided portions.

The titanium powder configuring the ejection powder is heated at the surface of the food product contact member by this thermal energy, and the titanium is activated and adsorbed to the surface of the food product contact member and diffuses and penetrates therein. When this occurs, the surface of the titanium reacts with oxygen present in compressed gas or oxygen present in the atmosphere, and is oxidized thereby so as to form a surface layer containing a base material and titanium oxide (TiO₂) diffused and penetrated into the base material at the surface of the food product contact member.

The thickness of the titanium oxide containing surface layer is approximately 0.5 μm, and is activated and adsorbed to the micronized surface structure formed on the surface of the food product contact member by the instantaneous heat treatment. The titanium oxide (titanium oxide and precious metal in cases containing a precious metal powder) diffuses and penetrates inward from a surface of a member of the food product contact member to a depth of approximately 5 μm.

Note that the titanium diffused and penetrated into the surface layer formed in this manner is oxidized by reaction with oxygen in compressed gas or the atmosphere due to heat generated during collision. This means that a tilting structure is generated in which there is a lot of bonding with oxygen at a proximity to the surface where the temperature is highest, and the amount of bonding with oxygen gradually decreases on progression further inward from the surface.

### EXAMPLES

A description will now be given of results of a corrosion resistance evaluation test performed on a test piece of a food product contact member according to the present invention as Test Example 1, results of an antibacterial test on a test piece subjected to the surface treatment of the present invention as Test Example 2, and application examples of food product contact members corresponding to various food products as Test Examples 3 to 7.

### Test Example 1: Corrosion Resistance Test

### (1) Test Objective

The test objective was to confirm that a food product contact member according to the present invention would exhibit a corrosion inhibiting effect in an environment not irradiated with light.

### (2) Test Method

SUS 304 was welded (TIG welded) and imparted with a tensile residual stress to produce a test piece susceptible to stress corrosion cracking. A CASS test according to JIS H 8502:1999 “7.3 CASS Test Method” was then performed on a welded test piece that was otherwise untreated, and on a welded test piece of the food product contact member according to the present invention (surface treated with instantaneous heat treatment+titanium powder ejection).

The CASS test performed here differs from a salt spray test performed by simply spraying salt water, and is a corrosion resistance test performed by spraying a brine adjusted to an acidity of from pH 3.0 to pH 3.2 by the addition of copper II chloride and acetic acid. This means that the CASS test is a test of corrosion resistance performed in an extremely hash corrosion environment.

Note that the test conditions of the CASS test are as listed in the following Table 1.

TABLE 1
CASS Test Conditions

| Item | When Adjusted | During Test |
|---|---|---|
| Sodium chloride concentration in g/L | 50 ± 5 | 50 ± 5 |
| Copper II chloride (CuCl₂•H₂O) | 0.26 ± 0.02 | — |
| concentration in g/L | | |
| pH | 3.0 | 3.0 to 3.2 |
| Spray rate in ml/80 cm²/h | — | 1.5 ± 0.5 |
| Temperature inside test chamber in ° C. | — | 50 ± 2 |
| Temperature of brine tank in ° C. | — | 50 ± 2 |
| Temperature of saturated air | — | 63 ± 2 |
| vessel in ° C. | | |
| Compressed air pressure in kPa | — | from 70 to 167 |

### (3) Test Result and Interpretation

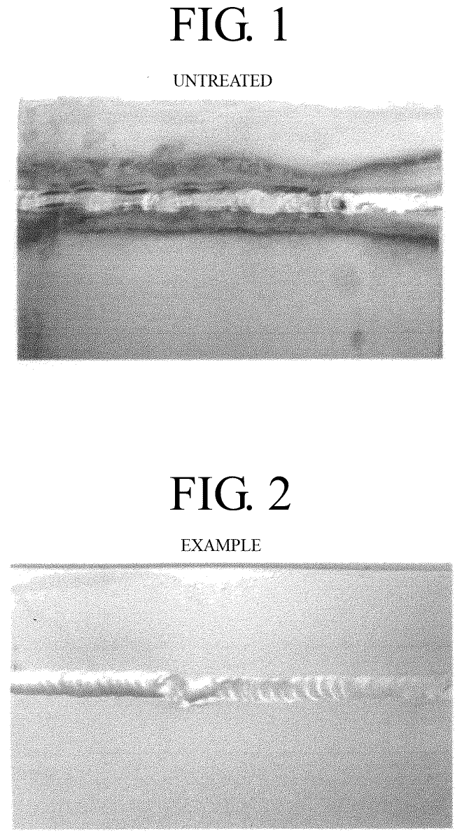

The state of test pieces after the CASS test are respectively illustrated in FIG. 1 (untreated) and FIG. 2 (Example).

As illustrated in FIG. 1, the generation of rust was observed on the surface of the untreated test piece.

In contrast thereto, on the test piece of the food product contact member according to the present invention, no rust generation was observed and the clean state present prior to the CASS test was maintained, as illustrated in FIG. 2, confirming that extremely high corrosion resistance was obtained for the test piece.

In shot peening, tensile residual stress that has been generated in a test piece by welding is released, and a compressive residual stress is imparted thereto. This is accordingly known to have an advantageous effect of inhibiting stress corrosion cracking, however is not directly prevent development of corrosion (rust).

Thus in the test piece of the food product contact member according to the present invention, the advantageous effect of preventing rust generation, rather than being advantageous effects of the instantaneous heat treatment performed by spherical shot ejection, are thought to actually be obtained by the titanium oxide coating film formed on the surface of the food product contact member by the titanium powder ejection having exhibited a photocatalyst-like or semiconductor catalyst-like function (reduction function).

Note that a CASS test is a test performed using a lidded test chamber in order to maintain the environment inside the test chamber in a constant state, and light is accordingly not irradiated onto the test piece during testing.

However, the CASS test is performed by testing in a state in which the temperature inside the test chamber is 50° C.±2° C., and so the temperature of the test piece is also warmed to 50° C.±2° C. The titanium oxide coating film is thought to exhibit the photocatalyst-like or semiconductor catalyst-like function due to testing being performed in such a warmed state.

Although the reason that titanium oxide exhibited a photocatalyst-like function even in an environment not irradiated with light in this manner is not completely clear, industrially manufacture titanium oxide loses oxygen when heated to a high temperature, and changes from a white color to a black color. The material that has turned such a black color exhibits the properties of a semiconductor. Namely, semiconductor-like properties are exhibited when in a state in which there is a deficit of oxygen bonding.

The titanium oxide diffused and penetrated into the surface of the food product contact member by method of the present invention, as stated above, has a tilting structure in which the amount of bonding to oxygen is greatest at a proximity to the surface of the food product contact member, and the amount of bonding to oxygen gradually decreases on progression inward from the surface. The titanium oxide present inside accordingly has a deficit of bonding to oxygen, and this is thought to be the reason why semiconductor-like properties are exhibited thereby.

Thus by being employed under warming, charge migration is thought to occur due to thermal excitation, so as to have a catalyst-like (referred to as a “semiconductor catalyst-like” in the present specification) function triggering a charge-migration type of oxidation-reduction effect.

Generally a semiconductor catalyst needs to be a catalyst having a special structure, such as being doped with an electron donor element or with an electron acceptor element. Obtaining the advantageous effect of exhibiting a catalytic action with heat by using the titanium oxide coating film obtained by the comparatively simple method of titanium powder ejection is an advantageous effect that greatly exceeds expectations.

Note that the surface roughness Ra was 0.3 μm at a smooth portion in the vicinity of the weld on the test piece after being subjected to instantaneous heat treatment by the ejection of 400 grit (diameter from 30 μm to 53 μm) shot made from HSS ejected at an ejection pressure of 0.5 MPa thereon, and the surface hardness was improved to 580 HV from an untreated state of 300 HV.

The surface roughness Ra was improved to 0.2 μm at a smooth portion in the vicinity of the weld portion on the Example test piece of the present invention that was a test piece subjected to instantaneous heat treatment under the above conditions, and then further subjected to ejection of titanium powder of particle diameter from 45 μm to 150 μm ejected at an ejection pressure of 0.4 MPa. The surface hardness after treatment was also maintained without change at 580 HV.

The hardness of titanium is about 300 HV, however the hardness of titanium oxide (TiO₂) which is an oxide of titanium, reaches a hardness of 1000 HV. Thus the surface hardness of the titanium powder used for ejection is accordingly a hardness of about 1000 HV which is higher than 580 HV, that is, surface hardness of the test piece after the instantaneous heat treatment from forming an oxide coating film.

Thus in the surface treatment method of the present invention, the titanium powder ejection against the surface after instantaneous heat treatment is thought to smooth by pressing and collapsing protrusion tips of surface indentations and protrusions formed by the collision of shot during the instantaneous heat treatment, so that burnishing is performed.

Namely, not only are there depressions (dimples) formed by the collision of shot on the surface of the test piece after instantaneous heat treatment, but a state is achieved in which acute protrusions are also formed between one and another of the formed depressions.

In contrast thereto, by further performing the titanium powder ejection against the surface after instantaneous heat treatment, smoothing (burnishing) is achieved by pressing and collapsing the protrusions of the indentations and protrusions that had been formed on the surface. The surface achieved thereby, which lacks pointed protrusions and has been deformed into a smoothed profile with depressions alone, is thought to be why the numerical value of the surface roughness Ra is reduced in this manner.

Thus the surface treatment method for a food product contact member according to the present invention not only makes it more difficult for a food product to stick by reducing the contact surface area with the food product while leaving the depressions (dimples) that were generated by the instantaneous heat treatment, but also presses, collapses, and smooths apex portions of pointed protrusions, which would provide resistance when contacting a food product. The surface of the food product contact member accordingly not only exhibits an improved food product non-stick effect that accompanies the antifouling and anticorrosion due to the photocatalyst-like or semiconductor catalyst-like effect of the titanium oxide, but after processing the surface itself is thought to have an improved and superior structure to which a food product is not liable to stick.

### Test Example 2: Antibacterial Test

### (1) Test Objective

To confirm that a food product contact member of the present invention exhibits an antibacterial effect.

### (2) Test Method

A test piece of the food product contact member according to the present invention and an untreated test piece were each placed on a sterilized Petri dish, 0.3 mL of an inoculation bacterial solution of Legionella bacterium (Legionella pneumophila) that causes a bacterial infection was employed to inoculate each test surface, and after covering with a covering film, the Petri dishes were kept in conditions of 40° C. and 90% or more of relative humidity for a contact time of 1 to 3 hours while being irradiated with black light. After 1 hour or 3 hours, any test bacterial solution adhering to the sample and the covering film was washed off into another sterilized Petri dish using a sterilized phosphoric acid buffer solution.

The washed off bacterial solution was incubated at 35° C. for 5 days using a Legionella MWY agar culture (made by Kanto Chemical Co., Inc.) and a bacteria count was found. The test results are listed in Table 2 below.

TABLE 2
Antibacterial Test Results of Legionella
Bacterium (units: CFU/mL)

| | After | After | After |
|---|---|---|---|
| | 0 minutes | 60 minutes | 180 minutes |
| Present invention test piece | 1.2 × 10⁴ | 5.0 × 10³ | Not detected |
| Untreated test piece | | 1.2 × 10⁴ | 8.6 × 10³ |

### (3) Test Results and Interpretation

There was no reduction at all in the Legionella bacteria after 60 minutes with the untreated test piece, and there was only a slight reduction in the count after the passage of 180 minutes.

In contrast thereto, the number of Legionella bacteria was reduced to half or fewer after 60 minutes with the test piece of the food product contact member according to the present invention, and the number of Legionella bacteria also reduced to a state in which none were detected after 180 minutes, confirming that a high antibacterial effect was obtained.

Moreover, exhibiting such a high antibacterial effect enabled confirmation that the titanium oxide diffused and penetrated into the surface of the test piece by titanium powder ejection exhibited a photocatalyst-like or semiconductor catalyst-like function.

Note that although details are omitted, it was also confirmed by testing that performing the surface treatment by the method of the present invention resulted in antibacterial properties not only against the Legionella bacterium, but also against Staphylococcus aureus and Escherichia coli.

Thus performing the surface treatment by the method of the present invention imparted high antibacterial properties, and so the surface treatment of the present invention can be said to be appropriate as a surface treatment for a food product contact member that contacts a food product.

### Test Example 3: Processing Example on a Drying Mesh for Dried Fruit Production

### (1) Treatment Conditions

A drying mesh made from a metal (SUS 304) and used for placing the flesh of sliced fruit on for drying when producing dried fruit (mangoes) was employed as the food product contact member, and such a drying mesh was subjected to the surface treatment of the present invention under the conditions listed in Table 3 below (Example 1).

A drying mesh subjected to fluoroplastic coating (Comparative Example 1) and an untreated drying mesh (Comparative Example 2) were used as comparative examples.

TABLE 3
Treatment Conditions of Drying Mesh for Drying Dried Fruit (SUS 304)

| Food Product Contact Member | | Drying mesh for drying dried fruit (mango) | |
|---|---|---|---|
| Dimensions | | Mesh: No. 8 (opening 2.362 mm); wire diameter: | |
| | | 0.8 mm; Size: 500 mm × 500 mm | |
| Substance | | SUS 304 | |
| | | Instantaneous Heat | Titanium Powder |
| | | Treatment | Ejection |
| Blasting Apparatus | | Gravity Type | Direct Pressure Type |
| | | (SGF-4A: made by Fuji | (FD-4: made by Fuji |
| | | Manufacturing Co. Ltd) | Manufacturing Co. Ltd) |
| Ejection | Substance | alumina-silica beads | titanium powder |
| Material | | (hard beads FHB) | |
| | Grain Size | 300 grit | 100 grit or coarser |
| | | (from 45 μm to 63 μm | (from 45 μm to 150 μm |
| | | diameter) | diameter) |

| | | |
|---|---|---|
| Ejection Pressure | 0.4 MPa | 0.4 MPa |
| Nozzle Diameter | φ 9 mm long | φ 5 mm long |
| Ejection Distance | 100 mm to 150 mm | 150 mm to 200 mm |
| Ejection Time | All surfaces, 8 directions: 1 | All surfaces, 8 directions: 1 |
| | minute × 8 | minute × 8 |

### (2) Test Method and Test Results

A drying mesh subjected to the surface treatment by the method of the present invention (Example 1), a drying mesh subjected to fluoroplastic coating (Comparative Example 1), and an untreated drying mesh (Comparative Example 2) were each employed to produce dried fruit (mango).

Mango sliced at a thickness of 5 mm was arranged on each of the drying meshes of the Example 1 and Comparative Examples 1, 2 placed inside a drying box (dark chamber), and drying was performed by introducing hot air from a heater into the drying box for 24 hours. The separability of the finished dried fruit when collected and the state of soiling of the drying mesh after separation were observed. The results thereof are listed in Table 4.

TABLE 4
Test Results of Drying Mesh for Drying Dried Fruit

| | Surface | |
|---|---|---|
| | Roughness (Ra) | Soiling/Separability |
| Example 1 | 0.3 μm | No fruit sugar sticking and good |
| (present | | separability. |
| invention) | | Reusable merely by cleaning by rinsing |
| | | with water after use. |
| | | Effectiveness maintained even after 1 |
| | | month of use. |
| Comparative | 0.1 μm | No fruit sugar sticking and good |
| Example 1 | | separability. |
| (fluoroplastic | | Re-coating needed approximately every |
| coating) | | month. |
| Comparative | 0.1 μm | Fruit sugar sticking and poor |
| Example 2 | | separability. |
| (untreated) | | Needed cleaning using cleaning agent |
| | | and brush each time used. |

### (3) Interpretation Etc.

There were few problems with fruit sugar sticking and poor separation and the like for the drying mesh subjected to the fluoroplastic coating (Comparative Example 1), however re-coating of the fluoroplastic was needed approximately every month due to the coating film detaching.

Moreover, due to concerns that some detached coating might be incorporated into the food product as a foreign object, there has been a transition recently to stop employing fluoroplastic coated products and to use untreated drying mesh (Comparative Example 2).

However, in cases in which an untreated drying mesh (Comparative Example 2) is employed, there is soiling due to fruit sugar sticking, and there is significant soiling of the drying mesh after use due to flesh of the fruit sticking due to poor separation. Thus in the untreated drying mesh (Comparative Example 2), there is a need to clean the drying mesh using a cleaning agent and brush each time used. The treatment after use results in a great cost from the considerable effort and time spend for cleaning after use and from the large volume of water consumed in cleaning.

In contrast thereto, with the drying mesh subjected to the surface treatment by the method of the present invention (Example 1), similarly to when fluoroplastic coating was performed, there was no sticking of fruit sugars, no poor separation was observed, and no dirt was observed to be sticking when visually inspected after use.

Moreover, with the drying mesh (Example 1) subjected to the surface treatment by the method of the present invention by titanium powder ejection, reuse was possible by merely washing with water after use due to an antibacterial effect also being exhibited (see Test Example 2: Antibacterial Test described above). Furthermore, there was no need to repeat the surface treatment due to the effects of surface treatment being maintained over the passage of a month.

Such advantageous effects with the drying mesh subjected to the surface treatment by the method of the present invention (Example 1) are thought to be advantageous effects obtained for the following reasons: a reduction in contact area between fruit flesh and the surface of wire material configuring the drying mesh due to dimples being formed thereon by the instantaneous heat treatment; maintenance of the advantageous effects of surface treatment, which resulted in an improvement in wear resistance and the like due to the surface structure of the wire material being micronized and hardened by the instantaneous heat treatment, over a prolonged period of time; and titanium oxide from ejecting titanium powder diffusing and penetrating into the surface of the wire material and the titanium oxide functioning in a photocatalyst-like or semiconductor catalyst-like manner such that dirt is not liable to stick and any adhered dirt is decomposed.

Note that in the present test, the production of dried fruit in this manner is performed inside a drying box that is dark chamber, and so similarly to in the corrosion resistance test described above (Test Example 1), advantageous effects of antifouling and good separability etc. are thought to arise from a catalytic function activated by heat.

Moreover, with the drying mesh subjected to the surface treatment by the method of the present invention (Example 1), the advantageous effect of being able to prevent bowing of the metal mesh was also confirmed.

### Test Example 4: Processing Example of Material Charging Funnel

### (1) Treatment Conditions

A material charging funnel installed to a food product manufacturing device (lower end outlet diameter 30 mm, upper end inlet diameter 140 mm, height 270 mm) was employed as a food product contact member, and the entire inner surface of the funnel and part of the outer surface thereof (a range of 30 mm height from the lower end outlet) was subjected to surface treatment by the method of the present invention (Example 2) under the conditions listed in Table 5 below.

An untreated funnel (Comparative Example 3) was employed as a comparative example.

TABLE 5
Treatment Conditions of Material Charging Funnel (SUS 316)

| Food Product Contact Member | | Material charging funnel: | |
|---|---|---|---|
| Dimensions | | lower end outlet diameter 30 mm; upper end | |
| | | inlet diameter 140 mm; height 270 mm | |
| Substance | | SUS 316 | |
| | | Instantaneous Heat | Titanium Powder |
| | | Treatment | Ejection |
| Blasting Apparatus | | Gravity Type | Direct Pressure Type |
| | | (SGF-4A: made by Fuji | (FD-4: made by Fuji |
| | | Manufacturing Co. Ltd) | Manufacturing Co. Ltd) |
| Ejection | Substance | alumina-silica beads | titanium powder |
| Material | | (hard beads FHB) | |
| | Grain Size | 400 grit | 100 grit or coarser |
| | | (from 38 μm to 53 μm | (from 45 μm to 150 μm |
| | | diameter) | diameter) |

| | | |
|---|---|---|
| Ejection Pressure | 0.3 MPa | 0.4 MPa |
| Nozzle Diameter | φ 9 mm long | φ 5 mm long |
| Ejection Distance | 100 mm to 150 mm | 150 mm to 200 mm |
| Ejection Time | Inner surface 5 minutes + | Inner surface 5 minutes + |
| | Outer surface 1 minute | Outer surface 1 minute |

### (2) Test Method and Test Results

Material was charged using the funnel subjected to the surface treatment by the method of the present invention (Example 2) and with the untreated funnel (Comparative Example 3), the state of sticking of the material and the state of corrosion developed due to salt and moisture in the material were observed, and a replacement time (lifespan) was evaluated for when poor sealing developed at a seal portion between the lower end outlet of the funnel and a pipe connected thereto due to corrosion and material sticking. The results thereof are listed in Table 6.

TABLE 6
Test Results of Material Charging Funnel

| | Surface | | |
|---|---|---|---|
| | roughness (Ra) | Corrosion/Sticking State | Lifespan |
| Example 2 | 0.2 μm | Good corrosion resistance, | 12 months |
| (present | | separability, and sealing | |
| invention) | | properties | |
| Comparative | 0.1 μm | Corrosion occurred in a short | 3 months |
| Example 3 | | period of time due to sticking | |
| (Untreated) | | of material, and poor sealing | |
| | | developed | |

### (3) Interpretation Etc.

Although generally a funnel having a fluoroplastic coating surface is employed for a material charging funnel, there is a tendency toward changing to an untreated funnel (Comparative Example 3) due to the problem of foreign objects being incorporated into food products.

However, when the untreated funnel (Comparative Example 3) was employed, corrosion developed in a comparatively short period of time due to the salt and moisture contained in the material. This brings develop poor sealing due to the material sticking to the seal portion between the lower end outlet of the funnel and the pipe connected to the lower end outlet, and the funnel needed to be replaced with a new funnel every approximately 3 months.

In contrast thereto, with the funnel subjected to the surface treatment by the treatment method of the present invention (Example 2), not only was material not liable to stick to the surface treated portion, but the titanium oxide from titanium powder ejection diffused and penetrated into the surface as described above, and exhibited a photocatalyst-like or semiconductor catalyst-like function, thereby making oxidation (corrosion) not liable to occur due to a reduction function thereof, and enabling corrosion of the seal portion to be prevented.

As a result, the funnel treated by the method of the present invention (Example 2) exhibited good sealing properties for a prolonged period of time, enabling the funnel to be used without replacement for approximately one year, i.e. four times the usage of the untreated funnel (Comparative Example 3).

Note that although a metallic odor of the funnel was transferred to the food product when the untreated funnel (Comparative Example 3) was employed, as a result of employing the funnel subjected to the surface treatment by the method of the present invention (Example 2), a metallic odor was not liable to be transferred to the food product.

As determined from the CASS test result listed above in “Test Example 1: Corrosion Resistance Test”, such advantageous effects are thought to be because corrosion resistance was improved by the catalytic action arising from the diffusion and penetration of titanium oxide, suppressing elution of metallic components into the food product, and decomposing odorous components by the catalytic action, and thereby enabling a metallic odor to be appropriately prevented from being transferred to the food product.

### Test Example 5: Processing Example of Rotor For Fixed Quantity Powder Packing Machine

### (1) Treatment Conditions

A metering rotor provided to a packing machine employed for fixed quantity packing of food powders was employed as a food product contact member. The metering rotor was a water wheel type having 10 plate shaped vanes welded in a radiating pattern to a hub, so as to be capable of supplying a fixed quantity of metered powder by holding between rotating vanes and feeding out in a packing step. Preliminary treatment was performed on the entire surface of the rotor by ejecting 400 grit (JIS R 6001-1973) (average of average diameter from 37 μm to 44 μm) SiC powder for an ejection time of approximately 10 minutes. This was then followed by surface treatment was performed by the method of the present invention (Example 3) under the conditions listed in Table 7 below.

A buffing polished rotor (Comparative Example 4) was employed as a comparative example.

TABLE 7
Treatment Conditions of Rotor For Fixed
Quantity Powder Packing Machine (SUS 304)

| Food Product Contact Member | | Rotor for fixed quantity powder packing machine: | |
|---|---|---|---|
| Dimensions | | | |
| Substance | | 10 vanes in waterwheel pattern; outer | |
| | | diameter 253 mm; overall length 250 mm. | |
| | | SUS 304 | |
| | | Instantaneous Heat | Titanium Powder |
| | | Treatment | Ejection |
| Blasting Apparatus | | Gravity Type | Direct Pressure Type |
| | | (SGF-4A: made by Fuji | (FD-4: made by Fuji |
| | | Manufacturing Co. Ltd) | Manufacturing Co. Ltd) |
| Ejection | Substance | alumina-silica beads | titanium powder |
| Material | | (hard beads FHB) | |
| | Grain Size | 400 grit | 100 grit or coarser |
| | | (from 38 μm to 53 μm | (from 45 μm to 150 μm |
| | | diameter) | diameter) |

| | | |
|---|---|---|
| Ejection Pressure | 0.3 MPa | 0.4 MPa |
| Nozzle Diameter | φ 9 mm long | φ 5 mm long |
| Ejection Distance | 100 mm to 150 mm | 150 mm to 200 mm |
| Ejection Time | Approximately 10 minutes | Approximately 10 minutes |

### (2) Test Method and Test Results

A rotor subjected to the surface treatment by the method of the present invention (Example 3) and a rotor subjected to buffing polishing (Comparative Example 4) were each mounted in a fixed quantity powder packing machine and fixed quantity packing of a powder was performed. The state of sticking of powder to the rotor and the state of corrosion developed were observed visually, and the replacement time was evaluated as the “lifespan”. The results thereof are listed in Table 8.

TABLE 8
Test Results of Rotor For Fixed Quantity Powder Packing Machine

| | Surface | | |
|---|---|---|---|
| | roughness (Ra) | Corrosion/Sticking State | Lifespan |
| Example 3 | 0.2 μm | No rust developed. No | 6 months |
| (present | | sticking of powder. | |
| invention) | | | |
| Comparative | 0.1 μm | Rust developed. Powder | 3 months |
| Example 4 | | stuck. | |
| (buffing | | | |
| polished) | | | |

### (3) Interpretation Etc.

The rotor subjected to buffing polishing (Comparative Example 4) was a rotor finished by polishing by a craftsman, and so had a higher cost than the rotor subjected to the surface treatment by the method of the present invention (Example 3), and also needed a longer lead time to delivery. However, rust developed in a comparatively short period of time at welded portions of the rotor subjected to buffing polishing (Comparative Example 4), and replacement was needed after approximately 3 months.

Moreover, powder stuck to the surface of the vanes and hub, and the adhered amount varied depending on the moisture absorption state of the powder and the like. This meant that a metering error was affected by the usage environment etc. and was not certain, meaning that fine adjustments were required at each usage occasion in order to perform accurate metering.

In contrast thereto, irrespective of the fact that the rotor subjected to the surface treatment by the method of the present invention (Example 3) had a lower cost and was able to be delivered with a shorter lead time, there was no rust developed on any portion of the rotor, including the welded portions, and moreover the powder also did not stick to the surface. This enabled a fixed quantity of powder to be accurately metered without fine adjustments or the like.

Moreover, the rotor subjected to the surface treatment by the method of the present invention (Example 3) had improved wear resistance and the like due to surface hardening, and so the advantageous effects described above were maintained over a prolonged period of time, enabling a replacement period of approximately 6 months to be achieved, which is an extension of lifespan to twice that of the buffing polished rotor (Comparative Example 4).

### Test Example 6: Piercing Rod For Wheat Flour Bag Opening Machine

### (1) Treatment Conditions

A piercing rod provided in a wheat flour opening machine was employed as the food product contact member. The wheat flour opening machine performs an operation to open a bag containing wheat flour that has been loaded into a hopper by piercing the bag with the piercing rod and taking the wheat flour out from inside the bag and into the hopper. Preliminary treatment was performed on an outer surface of the piercing rod by ejecting 400 grit (JIS R 6001-1973) (average of average diameter from 37 μm to 44 μm) SiC powder for an ejection time of approximately 1 minute. After the preliminary treatment, surface treatment was performed by the method of the present invention (Example 4) under the conditions listed in Table 9 below.

A piercing rod with a fluoroplastic coating on an outer surface (Comparative Example 5) was employed as the comparative example.

### (2) Test Method and Test Results

The piercing rod subjected to the surface treatment by the method of the present invention (Example 4) and the piercing rod subjected to fluoroplastic coating (Comparative Example 5) were each mounted in a wheat flour bag opening machine and used to pierce bags of wheat flour. The state of sticking of wheat flour to the outer surface of the piercing rod and the state of wear thereto were observed visually, and the replacement time was evaluated as the “lifespan”. The results thereof are listed in Table 10.

TABLE 10
Test Results of Piercing Rod For
Wheat Flour Bag Opening Machine

| | Surface | | |
|---|---|---|---|
| | roughness (Ra) | Wear/Sticking State | Lifespan |
| Example 4 | 0.2 μm | Neither wear nor sticking | 6 months |
| (present | | | |
| invention) | | | |
| Comparative | 0.1 μm | Wear and sticking developed | 3 months |
| Example 5 | | in a short period of time, | |
| (fluoroplastic | | replacement needed. | |
| coated) | | | |

### (3) Interpretation Etc.

SUS 440C is employed for piercing rods due to the need for strength. However, although the piercing rod subjected to fluoroplastic coating (Comparative Example 5) is able to prevent wheat flour from sticking to the surface, the fluoroplastic coating detaches due to wear at approximately 3 months, and corrosion is generated in the base material due to the fluoroplastic coating detaching.

In contrast thereto, although the advantageous effect of the piercing rod subjected to the surface treatment by the method of the present invention (Example 4) being able to prevent wheat flour from sticking to the surface is similar to that of the piercing rod subjected to fluoroplastic coating (Comparative Example 5), wheat flour is also not liable to stick even on days of high humidity with the piercing rod subjected to the surface treatment by the method of the present invention (Example 4).

This is thought to be because a catalytic effect is exhibited by the diffused and penetrated titanium oxide, such that moisture at the surface of the piercing rod is decomposed, and the adhered matter is decomposed.

Moreover, in the piercing rod subjected to fluoroplastic coating (Comparative Example 5) the advantageous effect of preventing wheat flour from sticking is lost when the fluoroplastic coating detaches due to wear at intervals of approximately 3 months and there is accordingly a need for replacement. However, with the piercing rod subjected to the surface treatment by the method of the present invention (Example 4), the advantageous effects such as preventing wheat flour from sticking, preventing rust, and the like are maintained for a duration of approximately 6 months, twice that of the Comparative Example 5.

### Test Example 7: Molding Punch For Pill Manufacturing Device

### (1) Treatment Conditions

A punch is employed as the food product contact member. The punch is provided in a pill manufacturing device for manufacturing pills as a medical product, and is employed together with a molding die to compress a powdered drug and mold the powdered drug into a pill. A punch that has been subjected to hard chromium plating is employed as the food product contact member, and surface treatment by the method of the present invention (Example 5) is performed on a surface of the punch under the conditions listed in Table 11 below.

A punch merely subjected to hard chromium plating (Comparative Example 6) is employed as a comparative example.

TABLE 11
Treatment Conditions of Molding Punch For Pill Manufacturing
Device (SKD-11 Chromium Plated Product)

| Food Product Contact Member | | Molding punch for pill manufacturing device | |
|---|---|---|---|
| Dimensions | | Major diameter 9 mm, minor diameter | |
| | | 5 mm, length 140 mm | |
| Substance | | SKD-11 hard chromium plated product | |
| | | Instantaneous Heat | Titanium Powder |
| | | Treatment | Ejection |
| Blasting Apparatus | | Gravity Type | Direct Pressure Type |
| | | (SGF-4A: made by Fuji | (FD-4: made by Fuji |
| | | Manufacturing Co. Ltd) | Manufacturing Co. Ltd) |
| Ejection | Substance | alumina-silica beads | titanium powder |
| Material | | (hard beads FHB) | |
| | Grain Size | 400 grit | 100 grit or coarser |
| | | (from 38 μm to 53 μm | (from 45 μm to 150 μm |
| | | diameter) | diameter) |

| Ejection Pressure | 0.4 | MPa | 0.4 | MPa |
|---|---|---|---|---|
| Nozzle Diameter | φ 9 mm long | | φ 5 mm long | |
| Ejection Distance | 100 | mm | 150 | mm |
| Ejection Time | 20 | seconds | 20 | seconds |

### (2) Test Method and Test Results

The punch subjected to the surface treatment by the method of the present invention (Example 5) and a chromium plated but otherwise untreated punch (Comparative Example 6) are each mounted to a pill manufacturing device and a powdered drug is compressed to manufacture pills. The state of sticking of the powdered drug and the state of wear were observed visually, and the replacement time was evaluated as the “lifespan”. The results thereof are listed in Table 12.

TABLE 12
Test Results of Molding Punch For Pill Manufacturing Device

| | Surface | | |
|---|---|---|---|
| | roughness (Ra) | Wear/Sticking State | Lifespan |
| Example 5 | 0.2 μm | Plating cracks eliminated | 4 months |
| (present | | and corrosion resistance | |
| invention) | | improved. | |
| Comparative | 0.1 μm | Sticking to plating cracks | 1 month |
| Example 6 | | and wear developed. | |
| (hard chromium | | | |
| plated) | | | |

### (3) Interpretation Etc.

There is normally a network of many cracks present on the surface of a hard chromium plated coating film, and in the hard chromium plated but otherwise untreated punch (Comparative Example 6), the powdered drug stuck to the crack portions and wear developed with these portions as the origin.

In contrast thereto, for the punch subjected to surface treatment by the method of the present invention (Example 5), the cracks present in the hard chromium plating were eliminated, and as a result the powdered drug could be prevented from sticking to these crack portions and wear originating at these cracks was able to be prevented from developing.

Moreover, in the punch subjected to the surface treatment by the method of the present invention (Example 5), the surface hardness was also raised and the above cracks were eliminated, which is thought to lead to a significant improvement in wear resistance.

Moreover, chromium and titanium are a combination of metals that readily transfer and dissolve each other, meaning that diffusion and penetration readily occurs when titanium oxide is activated and adsorbed to a hard chromium plated surface. The titanium oxide is thought to exhibit a photocatalyst-like or semiconductor catalyst-like function, improving the corrosion resistance of the punch, as well as also making dirt not liable to stick and facilitating the decomposition of any adhered dirt and the like.

This synergistic effect is thought to be the reason that although the lifespan of a punch in a hard chromium plated but otherwise untreated state (Comparative Example 6) is approximately 1 month, the lifespan of a punch subjected to the surface treatment by the method of the present invention (Example 5) can be increased to approximately 4 months, which is four times as long.

Note that for a molding punch employed in the pill manufacturing device, a punch subjected to diamond-like carbon (DLC) coating may be employed instead of chromium plating. However, although the lifespan is confirmed to be extended by a certain amount by the DLC coating, the lifespan could not be extended to four times that of the hard chromium plated punch, as was achieved by the punch subjected to the surface treatment by the method of the present invention. An extension to lifespan commensurate with the rise in cost could not be achieved. The punch subjected to the surface treatment by the method of the present invention (Example 5) could be said to exhibit excellent advantageous effects even in comparison to a punch subjected to DLC coating.

What is claimed is:

1. A food product contact member that makes contact with a food product, wherein:
the food product contact member is configured from a metal or a substance containing a metal;
the food product contact member includes a contact surface making contact with the food product and having a micronized structure;
plural smooth circular arc shaped depressions without pointed protrusions are formed over an entirety of the contact surface; and
titanium oxide is diffused and penetrated at a proximity to a surface of the contact surface contacting the food product.

2. The food product contact member of claim 1, wherein:
the thickness of a surface layer containing the titanium oxide is approximately 0.5 μm;
the titanium oxide is activated and adsorbed to the micronized surface structure formed on the surface of the food product contact member; and
the titanium oxide is diffused and penetrated to a depth of approximately 5 μm inward from a surface of a member of the food product contact member.

3. The food product contact member of claim 2, wherein:
the titanium oxide diffused and penetrated into the surface layer has a tilting structure in which there is a lot of bonding with oxygen at a proximity to the surface of the food product contact member and the amount of bonding with oxygen gradually decreases on progression further inward from the surface.
